(19) United States
(12) Patent Application Publication
(10) Pub. No.: US 2025/0087700 A1
(43) Pub. Date: Mar. 13, 2025

(54) SYSTEMS AND METHODS FOR COATING CATHODE ACTIVE MATERIAL

(71) Applicant: A123 Systems LLC, Novi, MI (US)

(72) Inventors: Srikanth Balijapelly, Waltham, MA (US); David Laughman, Acton, MA (US)

(21) Appl. No.: 18/827,582

(22) Filed: Sep. 6, 2024

Related U.S. Application Data
(60) Provisional application No. 63/581,951, filed on Sep. 11, 2023.

(51) Int. Cl. H01M 4/62; H01M 4/02; H01M 4/36; H01M 10/0525; H01M 10/0562

(52) U.S. Cl. CPC H01M 4/628; H01M 4/366; H01M 2004/021; H01M 2004/028; H01M 10/0525; H01M 10/0562; H01M 2300/0068

(57) ABSTRACT

Methods are provided for coating a cathode active material particle. The method includes preparing a lithium niobate precursor solution, wherein a ratio of lithium to niobium in the lithium niobate precursor solution is determined by a surface composition of the cathode active material particles, mixing the cathode active material particles with the lithium niobate precursor solution, hydrolyzing the mixture and then heating the mixture to obtain cathode active material particles coated with amorphous lithium niobate.

### CROSS REFERENCE TO RELATED APPLICATIONS

The present application claims priority to U.S. Provisional Application No. 63/581,951, entitled “SYSTEMS AND METHODS FOR COATING CATHODE ACTIVE MATERIAL” and filed on Sep. 11, 2023. The entire contents of the above-identified application(s) are hereby incorporated by reference for all purposes.

### FIELD

The present description relates generally to lithium metal oxide coatings on battery cathode particles.

### BACKGROUND AND SUMMARY

Solid state lithium ion batteries including solid state electrolytes are desirable due, in part, to increased safety achieved by replacing highly flammable conventional liquid electrolytes with less violently reactive solid state electrolytes. However, replacing the electrolyte may introduce additional unwanted side reactions that may degrade battery performance unless addressed. One example of such side reactions is decomposition of a sulfide based solid state electrolyte at interfaces with a cathode active material, leading to formation of byproducts which are both electronically and ionically insulating. Deposition of the byproducts on a surface of the cathode active material therefore results in increased cell impedance and decreased battery performance over time.

To prevent unwanted side reactions between the sulfide based solid state electrolyte and the cathode active material, cathode active material particles have been coated with a buffer layer to prevent direct contact between the sulfide based solid state electrolyte and the cathode active material. The buffer layer is configured to be ionically conducting and electrically insulating to allow transport of lithium ions to and from the cathode active material while still preventing unwanted side reactions. Lithium metal oxides and metal oxides including LiNbO₃, Li₃BO₃, Li₃PO₄, Li₄SiO₄, LiAlO₂, Al₂O₃, ZrO₂, Li₄Ti₅O₁₂, LiTaO₃, and LiNbₓTa₁₋ₓO₃ have been identified as coating materials having the desired properties. However, present systems and methods for coating cathode active materials with LiNbO₃ and other lithium metal oxides may rely on methods which result in undesirable carbon residues or demand heating to an excessively high temperature to remove carbon. Additionally, systems may not fully consider surface stoichiometry of the cathode active material and methods may not be optimized for achieving a thin and uniform coating with desired physical and electrical properties.

The inventors herein have identified the above problems and have determined solutions to at least partially solve them. In one example, a method for coating cathode active materials includes preparing a lithium niobate precursor solution wherein a molar ratio of lithium to niobium in the lithium niobate precursor solution is determined by a surface composition of the cathode active material particles, mixing the cathode active material particles with the lithium niobate precursor solution, hydrolyzing the mixture of lithium niobate precursor solution and cathode active material particles, and heating the hydrolyzed mixture to obtain the cathode active material particles coated with amorphous lithium niobate. The alkoxide hydrolysis route including calcination at a defined temperature range may be a cost effective and reproducible method for forming amorphous LiNbO₃ coating. By adjusting a molar ratio of lithium to niobium in the lithium niobate precursor solution according to the surface composition of the cathode active material particles, the desired 1:1 ratio of lithium to niobium in the coating is maintained. Further, controlling rate of water addition may be an effective process control for achieving a thin and uniform LiNbO₃ coating.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 shows a schematic diagram of a solid state lithium ion battery including a coated cathode material.

FIG. 2 shows a flowchart of an example of a method for synthesizing amorphous LiNbO₃.

FIG. 3 shows a graph depicting X-ray diffraction of LiNbO₃ powders.

FIG. 4 shows a flowchart of an example of a method for coating cathode active material powders with amorphous LiNbO₃.

FIG. 5 schematically shows a NCM particle with a LiNbO₃ coating.

FIG. 6 shows a first transmission electron microscope (TEM) image of NCM811 particles coated with LiNbO₃.

FIG. 7 shows a second TEM image of NCM811 particles coated with LiNbO₃.

FIG. 8 shows a graph depicting electrochemical impedance spectra (EIS) for coated and uncoated NCM cathode powders.

FIG. 9 shows a graph depicting retention as a function of cycle number for a solid state lithium ion battery (SS-LIB) including LiNbO₃ coated single crystalline NMC811 (SC-NMC) material and a SS-LIB including a LiNbO₃ coated polycrystalline NMC811 (PC-NMC) material.

FIG. 10 shows a graph depicting current density as a function of cycle number for the SS-LIB including SC-NMC and the SS-LIB including PC-NMC material.

FIG. 11 shows a graph depicting EIS spectra for the SS-LIB including the SC-NMC material and the SS-LIB including the PC-NMC material.

FIG. 12 shows a graph depicting voltage as a function of specific capacity for the SS-LIB including the SC-NMC material and the SS-LIB including the PC-NMC material.

### DETAILED DESCRIPTION

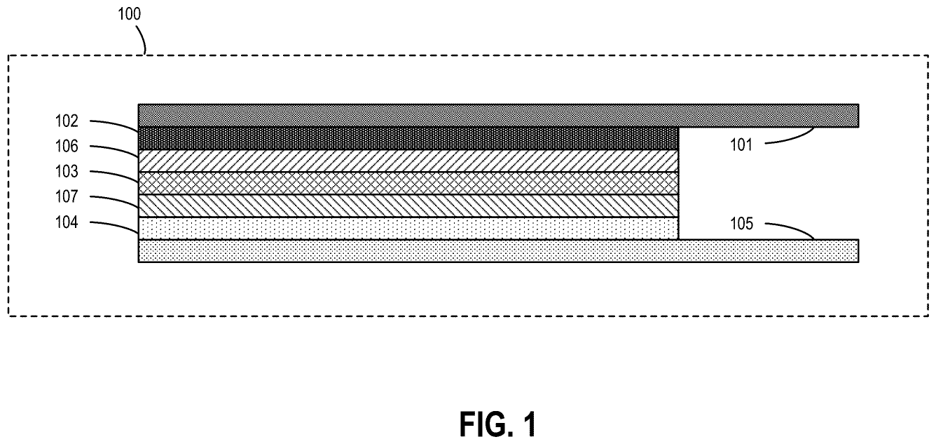

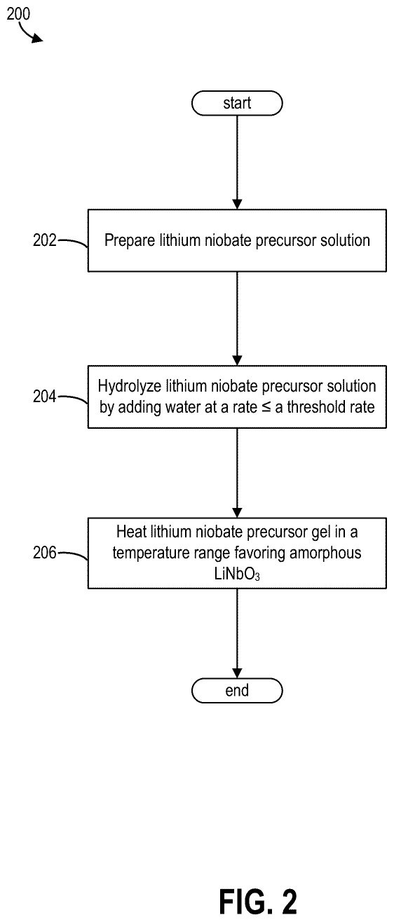

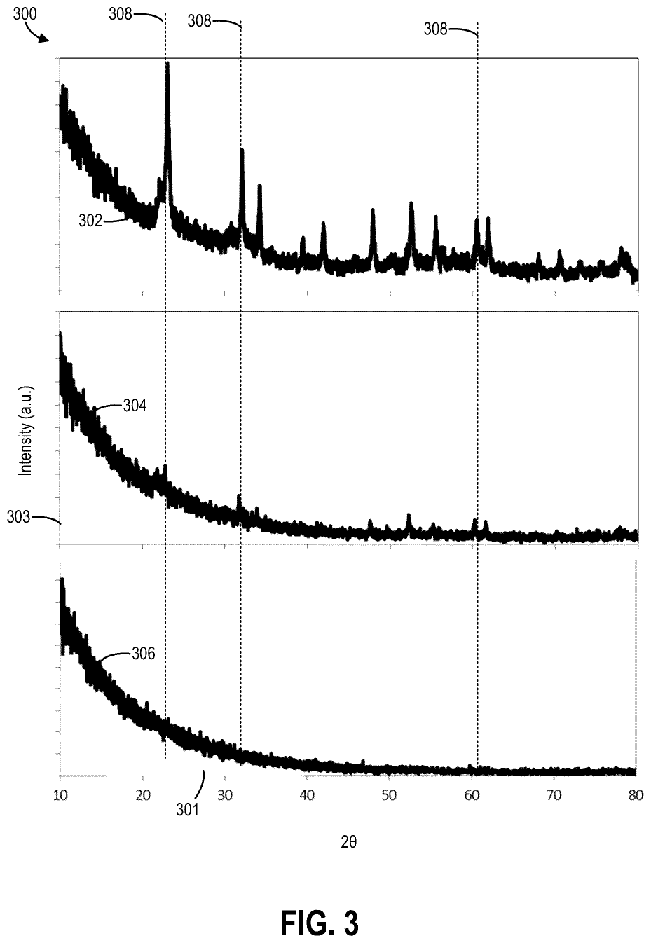

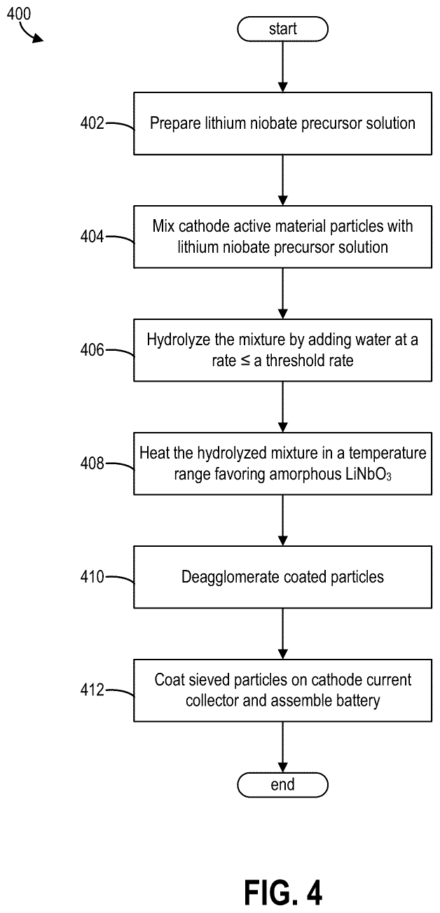

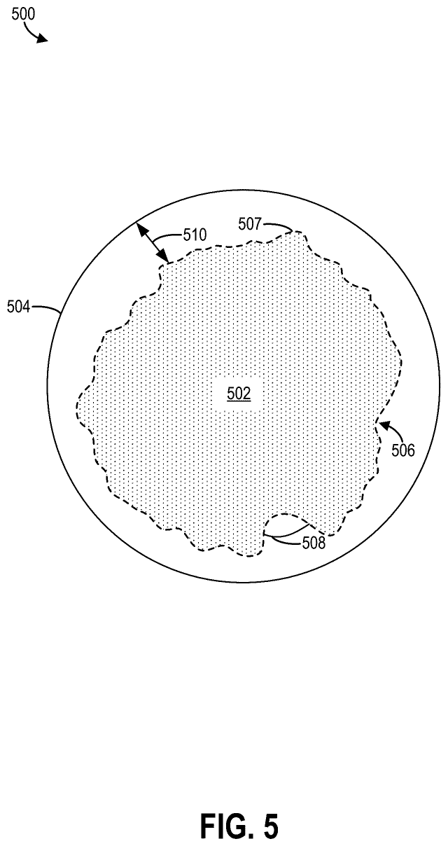

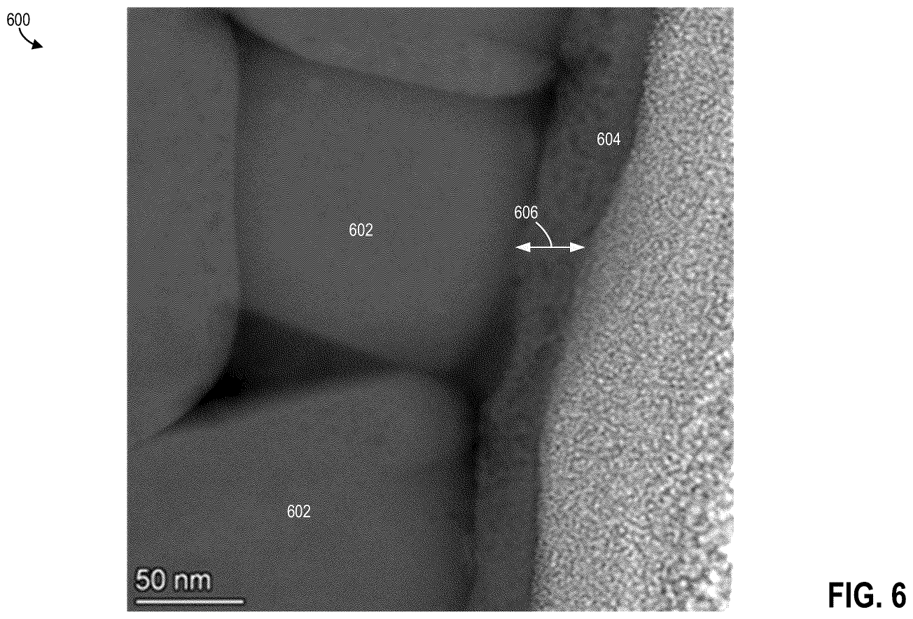

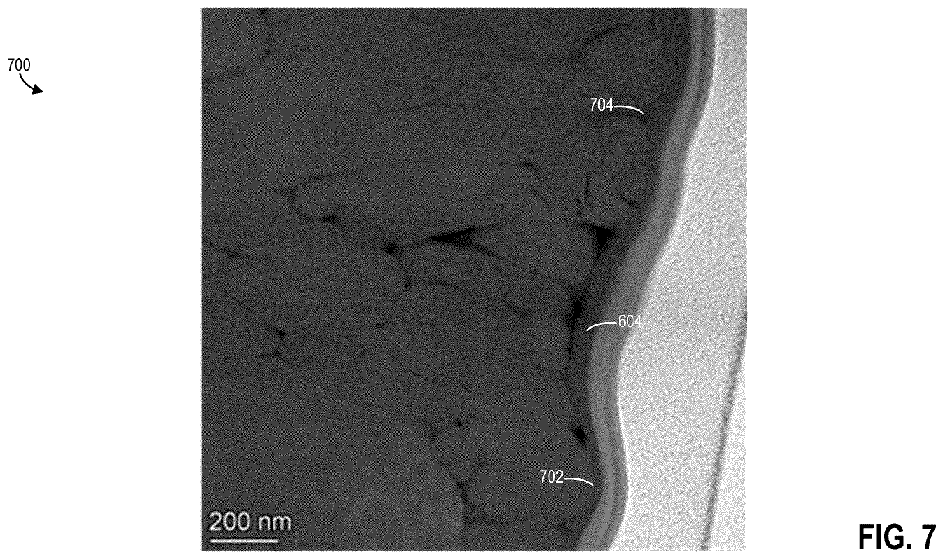

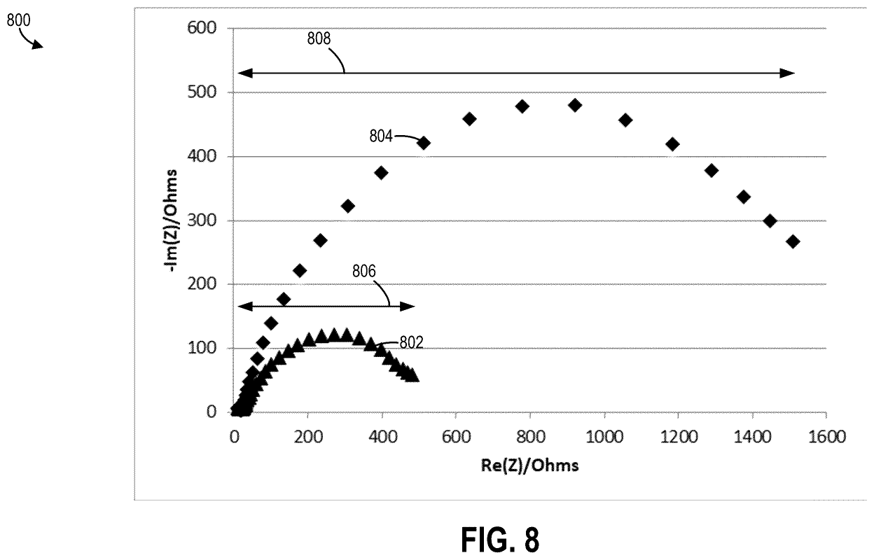

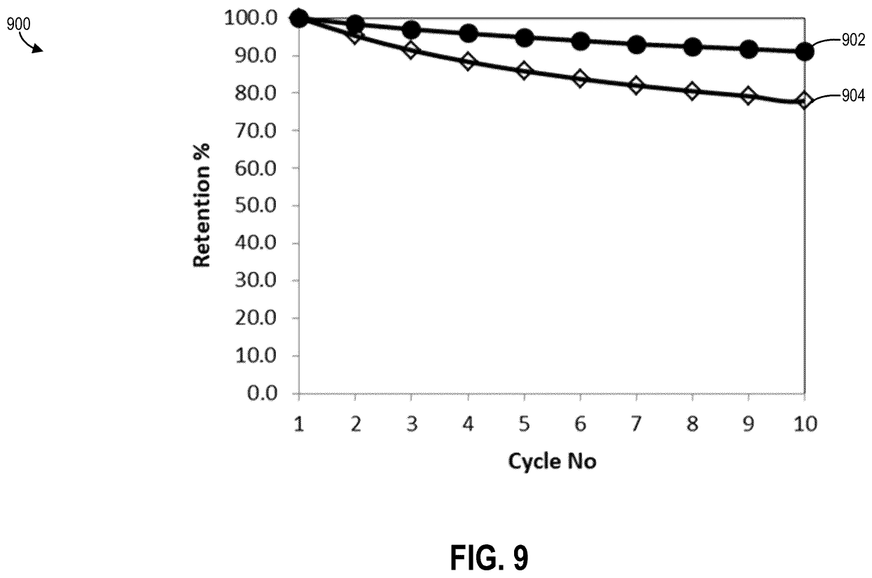

The following description relates to systems and methods for coating cathode active materials for a solid state lithium ion battery. An example of a solid state lithium ion battery is shown in FIG. 1. The solid state lithium ion battery may include a solid electrolyte such as a sulfide based electrolyte and a cathode of the solid state lithium ion battery may include lithium nickel cobalt manganese oxide (NCM) particles. To minimize unwanted side reactions and enhance performance of the solid state lithium ion battery the NCM cathode particles may be coated with LiNbO₃. Physical properties, such as carbon content and crystallinity, of the LiNbO₃ may affect the desired electrical properties. To understand LiNbO₃ physical properties, LiNbO₃ may be synthesized separately from cathode active material particles. A flowchart of an example of a method of synthesizing LiNbO₃ powders is shown in FIG. 2. Using the method shown in FIG. 2, an effect of calcination temperature on crystallinity may be determined as shown by X-ray diffraction (XRD) spectra of LiNbO₃ powders in FIG. 3. The method of FIG. 2 may be adapted for forming a LiNbO₃ coating on cathode active material particles, such as NCM811 particles. A flowchart of an example of a method for coating cathode active materials with LiNbO₃ is shown in FIG. 4. A coated NCM811 particle is shown schematically in FIG. 5 and TEM images showing a thin uniform coating of LiNbO₃ on NCM811 are shown in FIGS. 6-7. The NCM811 particles coated with LiNbO₃ according to the method of FIG. 4 may be incorporated into solid state lithium ion batteries which may show enhanced electrical properties as compared to solid state lithium ion batteries including uncoated NCM particles, as demonstrated by the graph of FIG. 8. NCM811 particles for cathodes may be either single crystal particles or polycrystalline particles. A LiNbO₃ coating may be applied to both single crystal and polycrystalline NCM811. An solid state lithium ion battery incorporating LiNbO₃ coated single crystal NCM811 may offer unexpected enhanced performance over one incorporating LiNbO₃ coated polycrystalline NCM811, as illustrated in the graphs shown in FIGS. 9-12.

Referring now to FIG. 1, an illustration of a non-limiting embodiment of a solid state lithium ion battery cell sub-assembly (e.g., the battery cell) 100, is depicted. Sequentially, the battery cell 100 may include an anode current collector 101, an anode material coating 102, an anode separator interfacial coating 106, a separator coating 103, a cathode separator interfacial coating 107, a cathode material coating 104, and a cathode current collector 105. As such, the separator coating 103 may function as a battery separator. In some examples of the solid state lithium ion battery cell sub-assembly 100, anode separator interfacial coating 106 and/or cathode separator interfacial coating 107 may be omitted. In further examples, multiple cathode separator interfacial coatings and/or anode separator interfacial coatings may be included.

One or more of the anode material coating 102 and the anode separator interfacial coating 106 may include an anode active material which contains lithium. One or more of the cathode material coating 104 and the cathode separator interfacial coating 107 may include a cathode active material which contains lithium. For example, the cathode active material may be LiNbO₃ coated cathode active material particles. Further, in some examples the coated cathode active material particles may be NCM or other cathode active material species. In examples where the coated cathode active materials are NCM, the NCM may be high nickel NCM, having a nickel content greater than 60 molar % (e.g., NCM811 LiNi_{0.8}Co_{0.1}Mn_{0.1}O₂). One or more of the anode material coating 102, the anode separator interfacial coating 106, the separator coating 103, the cathode separator interfacial coating 107, and the cathode material coating 104 may include a sulfide based electrolyte and polymer binder. The polymer binder may be electrically and ionically insulating. The sulfide based electrolyte may be one or more of, but not limited to, Li₆PS₅Cl, Li₇P₃S₁₁, Li₅PS₄ClBr, and Li₃PS₄.

In some examples, an adhesion interface may be defined between the separator coating 103 and an electrode structure. The adhesion interface may be a three-dimensional interface between the separator coating 103 and the electrode structure, such that the separator coating 103 may conform to, and permeate into, a surface of the electrode structure. As a first example, the electrode structure may be the anode material coating 102 deposited on the anode current collector 101, optionally with the anode separator interfacial coating 106 deposited thereon. As a second example, the electrode structure may be the cathode material coating 104 deposited on the cathode current collector 105, optionally with the cathode separator interfacial coating 107 deposited thereon.

Turning now to FIG. 2, an example of a method 200 for synthesizing LiNbO₃ powders is shown. LiNbO₃ powders may not be directly incorporated into a solid state lithium ion battery. Instead, the method 200 for synthesizing the LiNbO₃ powders may help inform a coating method discussed further below and may help to understand physical properties of the LiNbO₃, such as crystallinity, which may not be easily measured when in the presence of cathode active material.

Method 200 may be classified as an alkoxide hydrolysis method. The alkoxide hydrolysis method may be desirable due to producing product free of or with minimal residual carbon. Residual carbon at a surface of the cathode material particle may increase electrical conductivity, thereby leading to undesired electrochemical interactions at the particle surface. Reducing an amount of residual carbon may therefore improve electrical properties of the coating. LiNbO₃ coatings synthesized using an alkoxide method, such as method 200, may thereby be more insulating and less prone to electrochemical interactions than LiNbO₃ coatings formed using other methods which result in more residual carbon. At 202, method 200 includes preparing a lithium niobate precursor solution. The lithium niobate precursor solution may include a mixture of lithium alkoxide and niobium alkoxide in a non-aqueous solvent which is miscible with water. In one example, the lithium alkoxide may be lithium ethoxide and the niobium alkoxide may be niobium ethoxide. Additionally, lithium ethoxide may be provided by dissolving solid lithium metal in ethanol, alternatively lithium ethoxide may be supplied as a solid salt which is dissolved in ethanol. The precursor solution may be prepared with a 1:1 molar ratio of lithium to niobium.

At 204, method 200 includes hydrolyzing the lithium niobate precursor solution to form lithium niobate gel precursor by adding water at a rate less than or equal to a threshold rate. Adding water at less than or equal to the threshold rate may ensure that the water reacts completely with the lithium niobate precursor (e.g., lithium alkoxide and niobium alkoxide) in a hydrolysis reaction before condensation occurs. If water is added at a rate above the threshold rate, immediate condensation may be favored over hydrolysis. Immediate condensation instead of hydrolysis may result in an undesirable inhomogeneous gel precursor.

In one example, forming the precursor gel may include adding water in a molar proportion to moles of lithium/niobium. In one example, 4-12 moles of water may be added for every 1 mole of lithium/niobium. In an alternate example 5-10 moles of water may be added for every 1 mole of lithium/niobium. As a further example, the threshold rate of water addition may be based on adding water as a solution in the non-aqueous solvent at rate of less than or equal to 5 mL per minute. The solution may include water in a range from 2.5-10% by volume. In alternate examples, water may be added no faster than 0.01 mL/min. Adding water at below the threshold rate may be aided by first diluting water in ethanol and adding water as a water solution in the solvent of the precursor solution. Adding water slowly may favor the desired hydrolysis product of the reaction of water with the alkoxide precursors over an undesired condensation product. The precursor gel may form after stirring for a period of time at room temperature. In one example, the period of time may be as short as five minutes.

At 206, method 200 includes heating the precursor gel in a temperature range favoring formation of amorphous LiNbO₃ powders. A heating temperature range may determine a crystallinity of the LiNbO₃ powder. Amorphous LiNbO₃ may be a desired material for coating NCM particles in a solid state lithium ion battery. Although physically more fragile than crystalline LiNbO₃, amorphous LiNbO₃ may be less ionically insulating than crystalline LiNbO₃ (e.g., amorphous LiNbO₃ conductivity is on the order of 10⁻⁵ and crystalline LiNbO₃ conductivity is on the order of 10⁻¹⁰), thereby resulting in reduced resistance to lithium transfer when coated onto a cathode active material. In one example heating the precursor gel may include heating in oxygen. In such an example, oxygen gas may be flowed over the precursor gel at a flow rate between 2-2.5 standard cubic feet per hour (SCFH) during heating. A temperature range favoring formation of amorphous LiNbO₃ may be between 250° C. and 275° C. Heating above 275° C. may result in undesirable crystalline LiNbO₃. Additionally, insufficient heating may cause any residual organic material to remain as carbon interspersed with the LiNbO₃ powder. Carbon may be undesirable due to being electrically conductive. Method 200 may be desirable based on relatively low or no residual carbon remaining after heating. In other methods, high temperatures are demanded to reach low/no residual carbon which leads to these methods producing a crystalline LiNbO₃ coating instead of an amorphous one. Method 200 provides low/no residual carbon achieved after heating in a temperature range that is low enough that an amorphous LiNbO₃ coating is produced. Method 200 ends.

By preparing LiNbO₃ powders separately (e.g., not as a coating on a cathode material), physical properties of the LiNbO₃ may be more easily measured and observed. FIG. 3 shows examples 300 of XRD spectra of LiNbO₃ powders obtained via method 200 depicting intensity as a function of diffraction angle (2θ). Plot 302, 304, and 306 corresponds to LiNbO₃ powders heated at different temperatures at step 206 of method 200. Plot 302 corresponds to LiNbO₃ powders heated at 300° C., plot 304 corresponds to LiNbO₃ powders heated at 275° C., and plot 306 corresponds to LiNbO₃ powders heated at 250° C. Plots 302, 304, and 306 share a common x-axis 301 corresponding to diffraction angle. A y-axis 303 corresponds to intensity as arbitrary units. Plots 302, 304, and 306 are offset with respect to the y-axis 303 for clarity.

Plot 302, corresponding to heating at 300° C., shows clear diffraction peaks indicating a periodic crystalline structure capable of constructively diffracting x-rays. Lines 308 correspond to positions of some of the most intense peaks of plot 302. Looking at a position of lines 308 with respect to plot 304, some peaks may still be present although having a lower XRD intensity along the y-axis than plot 302. In this way, plot 304 indicates that heating at 275° C. may result in powders which have some localized areas of crystallinity, although a majority of the powder may be amorphous. Even looking at the positions of lines 308 as guides, no diffraction peaks are present in plot 306, indicating that heating at 250° C. results in amorphous LiNbO₃ powders. For this reason, 250° C. may be a preferred heating temperature for synthesizing a coating of LiNbO₃ on cathode active material, the amorphous material resulting in increased ionic conductivity.

Based on understanding methods and processing parameters that lead to desired LiNbO₃ powders, the method and processing parameters may be applied to a method for coating cathode active material particles. A flowchart of an example of a method 400 for coating cathode active material with LiNbO₃ via the alkoxide hydrolysis route is shown in FIG. 4.

At 402, method 400 includes preparing a lithium niobate precursor solution. The lithium niobate precursor solution may be a solution of lithium alkoxide and niobium alkoxide in a non-aqueous, water miscible solvent. In one example, a weight percent of the lithium niobate precursors in the lithium niobate precursor solution may be between 2% and 3%. Step 402 may be similar to step 202 of method 200. For example, preparing the lithium niobate precursor may include preparing a solution of lithium metal (or lithium ethoxide) and niobium ethoxide in ethanol. A relative molar ratio of lithium to niobium in the lithium niobate precursor solution may be tuned according a surface chemistry of the cathode active material. For example, a surface of the cathode active material may be lithium rich or lithium deficient based on the material and method of production. As one example the molar ratio of lithium to niobium may be in a range of 0.9-1.25:1. In this way, the lithium niobate coating may be formed with a desired 1:1 ratio of lithium to niobium. In some examples, the molar ratio of lithium to niobium may be 1.1:1.

At 404, method 400 includes mixing the cathode active material particles with the lithium niobate precursor solution. Mixing may include mixing the cathode active material particles and lithium niobate precursor solution for a period of time at room temperature. For example, the period of time may be in a range between 1 minute and 10 minutes. A mixing speed may be in range of 150 rpm to 2000 rpm. In this way, the lithium niobate precursors attach to the surface of the cathode active material particles. A weight percent of LiNbO₃ in a coated particle may determine a thickness of the LiNbO₃ coating formed by method 400. A coating which is too thin may not completely cover the cathode active material particle and may not prevent side reactions between the cathode active material and the electrolyte. A coating which is too thick may not effectively allow lithium ions or electrons to move through the coating when a battery including the cathode active material particles is charging and/or discharging. In one example, a weight percent of LiNbO₃ in the coated particles is between 0.1% and 3%. In alternate examples, the weight percent of LiNbO₃ in the coated particles is between 0.5% and 3%. In still further examples, the weight percent of LiNbO₃ in the coated particle is 1%.

In one example of method 400 the cathode active material particles may be NCM particles. In some examples, the cathode active material particles may be NCM811 particles. Additionally, the NCM811 particles may be single crystalline particles or polycrystalline particles. Additional types of cathode active material particles including lithium cobalt oxide (LCO), lithium iron phosphate (LFP), and lithium manganese nickel oxide (LMNO), and lithium nickel cobalt aluminum oxide (NCA), among others have also been considered.

At 406, method 400 includes hydrolyzing the mixture of lithium niobate precursor attached to cathode active material particles by adding water at a rate less than or equal to a threshold rate. The threshold rate may be similar to or the same as the threshold rate for adding water in step 204 of method 200. In one example, hydrolysis may be completed by adding 4-12 moles of water for every one mole of niobium in the mixture. In an alternate example, hydrolysis may be completed by adding 5-10 moles of water for every one mole of niobium in the mixture. Addition of water faster than the threshold rate may result in an undesirable turbid solution. Turbidity may occur due to a presence of excess of water driving condensation of the alkoxide precursors instead of the desired hydrolysis reaction. When condensation occurs before hydrolysis, hydrolysis is incomplete and the coating formed may not be molecularly homogeneous. For this reason, hydrolyzing the mixture of lithium niobate precursor attached to the cathode active materials includes adding water below the threshold rate. Adding water at or below the threshold rate may favor hydrolysis of the lithium niobate precursors over condensation of the lithium niobate precursors. In one example, the threshold rate may be less than or equal to 5 mL/min added as a solution of 2-10 vol. % water in the non-aqueous solvent. In some examples the solution may be a 5 vol % solution of water in the non-aqueous solvent. Additionally or alternatively, the threshold rate may be 0.1 ml of water per minute. Slowly adding water may ensure complete hydrolysis of the lithium niobate precursors to ultimately form the uniform coating of lithium niobate. After adding the total amount of water, the mixture may be stirred for less than or equal to 5 minutes at room temperature. At the end of 5 minutes, hydrolysis of the lithium niobate precursor may be complete.

At 408, method 400 includes heating the hydrolyzed mixture at a temperature range favoring amorphous LiNbO₃. As described above with respect to FIGS. 2-3, the heating may include heating under O₂ atmosphere at a temperature range between 250° C. and 275° C. In some examples, heating may include first removing solvent at lower temperatures under vacuum (e.g., via rotary evaporator at 65° C.), before heating the dried particles under O₂ atmosphere. In this way, crystallinity of the LiNbO₃ coating may be minimized as well as minimizing an amount of residual carbon and electrical properties of the LiNbO₃ coating for a cathode active material may be enhanced (e.g., increased ionic conductivity and decreased electrical conductivity). After heating, the cathode active material particles may include a uniform amorphous lithium niobate coating.

At 410, method 400 includes deagglomerating the coated particles. A particle size distribution of the cathode active material particles may not change significantly (e.g., by more than 5%) after coating. However, non-mechanically rigid agglomerates may form after heating. In one example, deagglomerating may include sieving the coated particles through a 40 μm mesh. In alternate examples, air jet milling or other deagglomeration techniques may be used.

At 412, method 400 includes coating the deagglomerated particles onto a cathode current collector and assembling a battery. In one example, coating the deagglomerated particles may include dispersing the coated cathode active material particles in a slurry including solid state electrolyte. The slurry may further include one or more of solvent, binder, carbon additives, among other known components of solid state lithium ion battery slurries. Coating the sieved particles may form a cathode material coating such as cathode material coating 104 of FIG. 1. The solid state electrolyte used in the coating may be a sulfide based solid state electrolyte. The cathode material coating may be further assembled into a battery such as the solid state lithium ion battery cell 100 of FIG. 1.

Turning now to FIG. 5, an illustration 500 is shown of a cross-section of a cathode active material particle 502 coated with an amorphous LiNbO₃ layer 504 according to method 400. In one example cathode active material particle 502 is NCM. Additionally, the cathode active material particle 502 may be NCM811. In one example, cathode active material particles may be formed of many primary particles agglomerated to form a spherical secondary particle. Such an example is shown in FIG. 5, and may include protrusions such as protrusion 507 and indents such as indent 506 formed by the agglomeration of primary particles. A desirable coating may uniformly coat a surface of cathode active material particle 502 and conforms to a surface of the cathode active material particle including conforming to both protrusion 507 and indent 506. In some examples, LiNbO₃ layer 504 may penetrate partially into the indent, resulting in a boundary 508 of LiNbO₃ which may not be in face sharing contact with cathode active material particle 502. LiNbO₃ layer 504 may be a thickness 510. Average thickness 510 may be in a range between 5 nm and 60 nm. In some examples, average thickness 510 may be in a range between 10 nm and 50 nm. In alternate examples average thickness 510 may be in a range between 5 nm and 30 nm. In further examples, average thickness 510 may be between 20 nm and 40 nm.

Turning now to FIG. 6, a first transmission electron microscope (TEM) image 600 of an NCM811 particle coated with LiNbO₃ according to method 400 is shown. As described above with respect to FIG. 5, the NCM811 particle includes a plurality of primary particles 602. Image 600 shows LiNbO₃ coating layer 604, formed as a substantially (e.g., +5%) uniform coating having a thickness 606. In one example, thickness 606 may be between 30 nm and 60 nm. FIG. 7 shows a second TEM image 700 of a NCM811 particle coated with LiNbO₃ according to method 400. A magnification of second TEM image 700 is less than a magnification of image 600. Image 700 shows a LiNbO₃ coating 604 conforming to protrusion 702. Protrusion 702 may be similar to protrusion 507 of FIG. 5. Additionally, image 700 shows LiNbO₃ coating 604 conforming to indent 704. Indent 704 may be similar to indent 506 of FIG. 5.

Cathode active material particles, such as NCM811 may be coated with LiNbO₃ and incorporated into a solid state lithium ion battery cell, such as battery cell 100 of FIG. 1. In one example, a sulfide based solid electrolyte may be included in the solid state lithium ion battery. Electrical characterization of a fully assembled solid state lithium ion battery may be performed using electrochemical impedance spectroscopy (EIS). FIG. 8 shows a graph 800 comparing an electrochemical impedance spectrum (plot 804) collected from a solid state lithium ion battery (SS-LIB) including uncoated NCM811 and an electrochemical impedance spectrum (plot 802) collected from an SS-LIB including NCM811 coated with LiNbO₃ according to method 400. Each of the SS-LIBs were charged at a voltage of 4.3V for 10 hours before measuring impedance. The SS-LIB including the uncoated NCM811 and the SS-LIB including the coated NCM811 were be made by the same coating formulation and battery assembly method.

A width 806 of a semi-circle formed by plot 802 and a width 808 of a semi-circle formed by plot 804 may each be proportional to an amount of resistance to charge transfer of lithium ions to and from the cathode active material. Width 806 of plot 802 is smaller than width 808 of plot 804. In this way, EIS shows that coating NCM811 with LiNbO₃ according to method 400 may effectively decrease a resistance to charge transfer of lithium ions in an SS-LIB and maintains the low resistance to charge transfer of lithium ions after 10 hours of operation. Further, the results show that a SS-LIB including LiNbO₃ coated cathode active material particles may have a decreased charge transfer resistance compared to a SS-LIB including uncoated cathode active material particles.

NCM811 may be obtained as single crystalline particles or as polycrystalline particles. In one example the single crystalline particles, of NCM811 of other cathode active material particles, may have a D50 in a range of 3 μm up to 5 μm. In alternate examples, the single crystalline particles may have a D50 in a range of 3 μm up to 4 μm. In further examples, the single crystalline particles may have a D50 of 3 μm. The polycrystalline particles may be sized to have a D50 of 10 μm. For conventional, liquid electrolyte lithium ion batteries, polycrystalline NCM811 having the larger particle size (e.g., 10 μm) may be preferred. However, performance of SS-LIBs with NCM811 coated with LiNbO₃ demands experimental comparison and experimentation to determine the most desirable cathode active material particle properties.

Single crystalline NCM811 (SC-NMC) and polycrystalline NCM811 (PC-NMC) may each be coated with LiNbO₃ according to method 400. Each of SC-NMC and PC-NMC may be coated with equivalent weight percent of LiNbO₃. In this way, a coating thickness on the SC-NMC may be thinner than a coating thickness on the PC-NMC, based on the smaller D50 of the SC-NMC and therefore larger surface area to volume ratio. A SS-LIB including LiNbO₃ coated SC-NMC and a SS-LIB including LiNbO₃ coated PC-NMC are constructed using substantially the same formulations and methods for comparison of a battery including coated SC-NMC to a battery including PC-NMC.

Turning now to FIG. 9. a graph 900 of retention percent as a function of cycle number is shown. Plot 902 corresponds to the SS-LIB including the LiNbO₃ coated SC-NMC and plot 904 corresponds to the SS-LIB including the LiNbO₃ coated PC-NMC. A cycle is a complete charging and discharging (e.g., from 0% state of charge [SOC] to 100% SOC) of the SS-LIBs. Retention percent corresponds to a relative amount of available capacity of the SS-LIB. Plot 902 decreases at a slower rate than plot 904 as the number of cycles increase. After 10 cycles, the retention percent of the SS-LIB including the SC-NMC is greater than the retention percent of the SS-LIB including the PC-NMC. The retention of the SS-LIB including the SC-NMC indicates that the coated SC-NMC degrades at a slower rate than the coated PC-NMC.

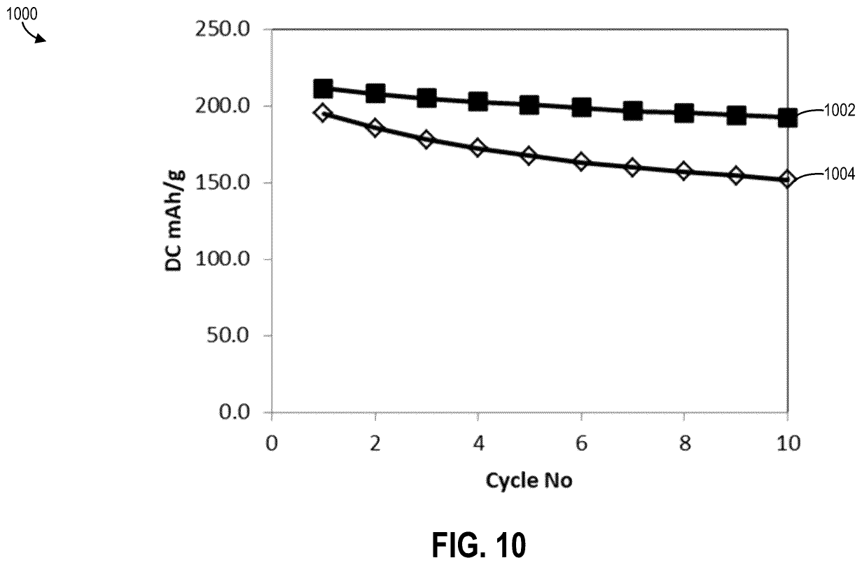

Turning now to FIG. 10, a graph 1000 of specific capacity in units of mAh/g as a function of cycle number is shown. Plot 1002 corresponds to the SS-LIB including the SC-NMC and plot 1004 corresponds to the SS-LIB including the PC-NMC. Even after 1 cycle, the specific capacity of plot 1002 starts at a higher amount than plot 1004. Additionally, plot 1002 decreases at a slower rate than plot 1004 as the number of cycles increase. After 10 cycles the specific capacity of the SS-LIB including the SC-NMC is greater than the specific capacity of the SS-LIB including the PC-NMC. The greater specific capacity of the SS-LIB including the SC-NMC further indicates that the battery including the coated SC-NMC is more robust and higher performing the battery including the coated PC-NMC.

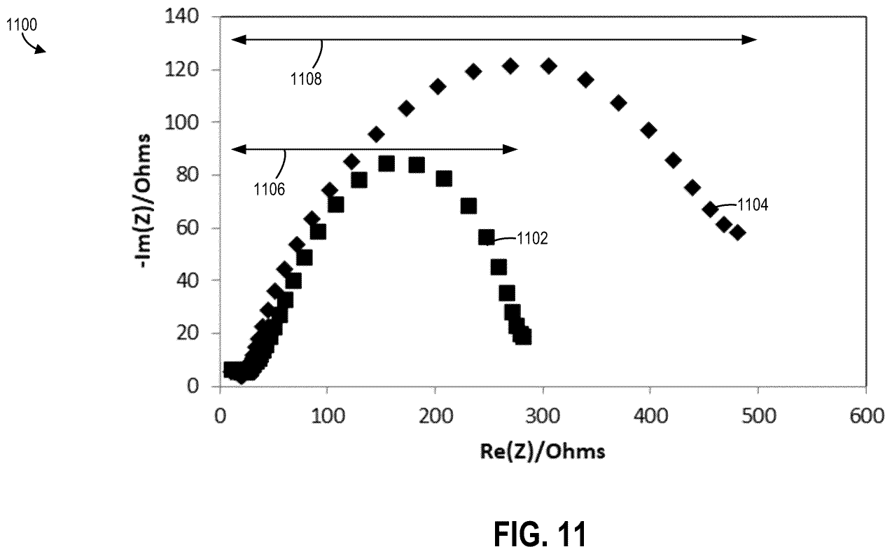

Turning now to FIG. 11, graph 1100, EIS of the SS-LIB including the LiNbO₃ coated SC-NMC and of the SS-LIB including the LiNbO₃ coated PC-NMC are shown. Each SS-LIB was held at a charge voltage of 4.3V for 10 hours before measuring impedance. Plot 1102 corresponds to the SS-LIB including the LiNbO₃ coated SC-NMC and plot 1104 corresponds to the SS-LIB including the LiNbO₃ coated PC-NMC. The semi-circle formed by plot 1102 has a width 1106 and the semi-circle formed by plot 1104 has a width 1108. Width 1106 is smaller than width 1108, indicating that the SS-LIB including the LiNbO₃ coated SC-NMC has a lower resistance to transfer of lithium ions from the cathode than the SS-LIB including the LiNbO₃ coated PC-NMC.

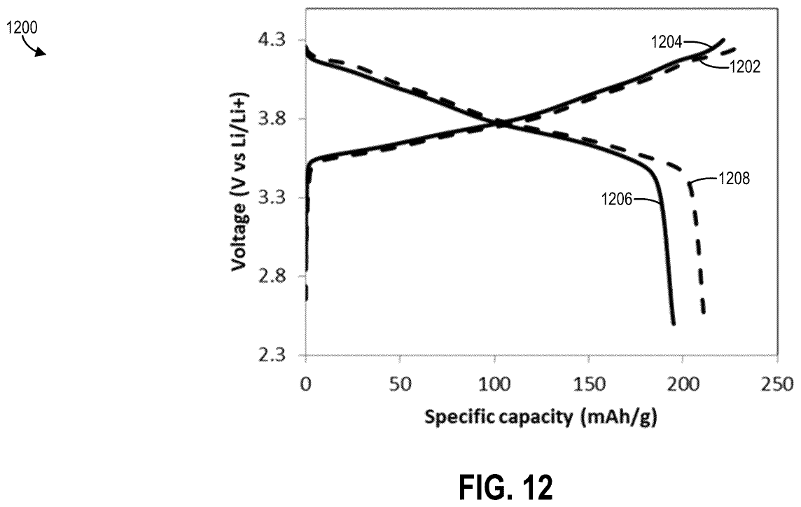

Turning now to FIG. 12, a graph 1200 of voltage vs Li/Li⁺ as a function of specific capacity including both a charge and a discharge profile for the SS-LIB including the LiNbO₃ coated SC-NMC and the SS-LIB including the LiNbO₃ coated PC-NMC is shown. Plot 1202 corresponds to charging the SS-LIB including the LiNbO₃ coated SC-NMC and plot 1208 corresponds to discharging the SS-LIB including the LiNbO₃ coated SC-NMC. Plot 1204 corresponds to charging the SS-LIB including the LiNbO₃ coated PC-NMC and plot 1206 corresponds to discharging the SS-LIB including the LiNbO₃ coated PC-NMC. Comparing plot 1206 to plot 1208, the SS-LIB including the LiNbO₃ coated SC-NMC shows a desirable increase in maximum discharge capacity compared to the SS-LIB including the LiNbO₃ coated PC-NMC. Additionally, The SS-LIB including the LiNbO₃ coated SC-NMC shows a lower over-potential at a start of the charge/discharge cycle than the SS-LIB including the LiNbO₃ coated PC-NMC.

As demonstrated in FIGS. 9-12, the SS-LIB including the LiNbO₃ coated SC-NMC shows surprisingly higher performance in terms of capacity retention, robustness over multiple cycles, and improved charge transfer. The combination of the amorphous LiNbO₃ coating on the small and single crystal NMC particles is surprisingly robust, without any evidence of detrimental effect caused by the amorphous/single crystal interface. In this way, the disclosure provides support for a cathode active material comprised of a core particle formed of lithium nickel manganese cobalt oxide (NMC); and a coating surrounding the core particle, wherein the NMC is single crystalline and the coating is formed of amorphous LiNbO₃. In a first example of the cathode active material a diameter of the NMC core is in a range of 3 μm up to 5 μm. In a second example of the cathode active material the coating is homogeneous.

The technical effect of method 400 is to provide a LiNbO₃ coating on a cathode active material particle. The molar ratio of lithium to niobium in a lithium niobate precursor solution may be selected based on a surface chemistry of the cathode active material particle chosen in order to maintain a 1:1 Li:Nb ratio of the coating. Further, the method may include hydrolyzing the precursor solution by slow addition of water in such a way that hydrolysis is favored over condensation, thereby promoting a uniform and even coating of LiNbO₃ over the cathode active material particle. The uniform and even coating may result in slowing degradation of the cathode active material over time when used in a SS-LIB including sulfide based electrolytes. Additionally, heating temperatures may be chosen such that an amorphous LiNbO₃ coating is formed, thereby reducing ionic resistance of the coating and thereby improving performance of the SS-LIB.

The disclosure also provides support for a method for coating cathode active material particles, comprising: preparing a lithium niobate precursor solution wherein a molar ratio of lithium to niobium in the lithium niobate precursor solution is determined by a surface composition of the cathode active material particles, mixing the cathode active material particles with the lithium niobate precursor solution, hydrolyzing the mixture of lithium niobate precursor solution and cathode active material particles, and heating the hydrolyzed mixture to obtain the cathode active material particles coated with amorphous lithium niobate. In a first example of the method, the cathode active material particles are NCM811 particles and the molar ratio of lithium to niobium in the lithium niobate precursor solution is more than 1. In a second example of the method, optionally including the first example, the cathode active material particles are NCM811 particles and the molar ratio of lithium to niobium in the lithium niobate precursor solution is 0.9 to 1.25:1. In a third example of the method, optionally including one or both of the first and second examples, a solids weight percent of lithium niobate precursors in the mixture of lithium niobate precursor solution and cathode active material particles is between 0.1% and 3%. In a fourth example of the method, optionally including one or more or each of the first through third examples, heating the hydrolyzed mixture includes heating in an 02 atmosphere at between 250° C. and 275° C. In a fifth example of the method, optionally including one or more or each of the first through fourth examples, hydrolyzing the mixture of lithium niobate precursor solution and cathode active material particles includes mixing after addition of water at room temperature for less than or equal to 5 minutes. In a sixth example of the method, optionally including one or more or each of the first through fifth examples, mixing the cathode active material particles with the lithium niobate precursor solution attaches lithium niobate precursors to a surface of the cathode active material particles.

The disclosure also provides support for a method, comprising: mixing cathode active material particles with a lithium niobate precursor solution, adding water to the mixture of lithium niobate precursor solution and cathode active material particles at a rate favoring hydrolysis of a lithium niobate precursor over condensation of the lithium niobate precursor, and heating the hydrolyzed mixture to obtain an amorphous lithium niobate coating on the cathode active material particles. In a first example of the method, the rate favoring hydrolysis of the lithium niobate precursor solution of over condensation of the lithium niobate precursor is less than or equal to 5 mL/min addition of a 5 vol % solution of water in a non-aqueous solvent. In a second example of the method, optionally including the first example, adding water includes adding water as a water solution in ethanol. In a third example of the method, optionally including one or both of the first and second examples, a thickness of the amorphous lithium niobate coating is between 5 nm and 60 nm. In a fourth example of the method, optionally including one or more or each of the first through third examples, the amorphous lithium niobate coating conforms to protrusions and indents on a surface of the cathode active material particles. In a fifth example of the method, optionally including one or more or each of the first through fourth examples, the amorphous lithium niobate coating is molecularly homogeneous.

The disclosure also provides support for a solid state lithium ion battery, comprising, an anode current collector, an anode material coating, a separator coating, and a cathode material coating, wherein the cathode material coating includes LiNbO₃ coated cathode active material particles formed by: preparing a lithium niobate precursor solution wherein a molar ratio of lithium to niobium in the lithium niobate precursor solution is determined by a surface composition of cathode active material particles, mixing the cathode active material particles with the lithium niobate precursor solution, hydrolyzing the mixture of lithium niobate precursor solution and cathode active material particles, and heating the hydrolyzed mixture to obtain the cathode active material particles coated with amorphous lithium niobate. In a first example of the system, the separator coating is formed of sulfur based solid state electrolyte.

In an alternate embodiment, the disclosure also provides support for a method, comprising, mixing lithium alkoxide, niobium alkoxide, and lithium nickel manganese cobalt oxide (NCM) particles in non-aqueous solvent, wherein a molar ratio of lithium alkoxide to niobium alkoxide is more than 1, hydrolyzing the mixture of lithium alkoxide, niobium alkoxide and NCM particles by adding water as at a rate of less than or equal to 0.1 mL/min, heating the hydrolyzed mixture under O2 atmosphere in a temperature range between 250° C. and 275° C. to form amorphous lithium niobate (LiNbO₃) coated NCM particles. In a first example of the method, the NCM particles are single crystalline particles. In a second example of the method, optionally including the first example, a D50 of the NCM particles is in a range of 3 μm to 5 μm. In a third example of the method, optionally including one or both of the first and second examples, the method further comprises: constructing a solid state lithium ion battery including the amorphous LiNbO₃ coated NCM particles in a cathode material coating of the solid state lithium ion battery. In a fourth example of the method, optionally including one or more or each of the first through third examples, the solid state lithium ion battery includes a sulfide based solid state electrolyte. In a fifth example of the method, optionally including one or more or each of the first through fourth examples, the amorphous LiNbO₃ coated NCM particles decrease a resistance to charge transfer of the solid state lithium ion battery when compared to a solid state lithium ion battery including uncoated NCM particles. In a sixth example of the method, optionally including one or more or each of the first through fifth examples, the molar ratio of lithium alkoxide to niobium alkoxide is 0.9-1.25:1.

Various modifications of the present invention, in addition to those shown and described herein, will be apparent to those skilled in the art of the above description. Such modifications are also intended to fall within the scope of the appended claims. The foregoing description is illustrative of particular embodiments of the invention, but it is not meant to be a limitation upon the practice thereof. The foregoing discussion should be understood as illustrative and should not be considered limiting in any sense. While inventions have been particularly shown and described with references to preferred embodiments thereof, it will be understood by those skilled in the art that various changes in form and details may be made therein without departing from the spirit and scope of the inventions as defined by the claims. The corresponding structures, materials, acts and equivalents of all means or steps plus function elements in the claims below are intended to include any structure, material or acts for performing the functions in combination with other claimed elements as specifically claimed.

Finally, it will be understood that the articles, systems, and methods described hereinabove are embodiments of this disclosure—non-limiting examples for which numerous variations and extensions are contemplated as well. Accordingly, this disclosure includes all novel and non-obvious combinations and sub-combinations of the articles, systems, and methods disclosed herein, as well as any and all equivalents thereof.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A method for coating cathode active material particles, comprising:
preparing a lithium niobate precursor solution wherein a molar ratio of lithium to niobium in the lithium niobate precursor solution is determined by a surface composition of the cathode active material particles;
mixing the cathode active material particles with the lithium niobate precursor solution;
hydrolyzing the mixture of lithium niobate precursor solution and cathode active material particles; and
heating the hydrolyzed mixture to obtain the cathode active material particles coated with amorphous lithium niobate.

2. The method of claim 1, wherein the cathode active material particles are NCM811 particles and the molar ratio of lithium to niobium in the lithium niobate precursor solution is more than 1.

3. The method of claim 1, wherein the cathode active material particles are NCM811 particles and the molar ratio of lithium to niobium in the lithium niobate precursor solution is 0.9 to 1.25:1.

4. The method of claim 1, wherein a solids weight percent of lithium niobate precursors in the mixture of lithium niobate precursor solution and cathode active material particles is between 0.1% and 3%.

5. The method of claim 1, wherein heating the hydrolyzed mixture includes heating in an O₂ atmosphere at between 250° C. and 275° C.

6. The method of claim 1, wherein hydrolyzing the mixture of lithium niobate precursor solution and cathode active material particles includes mixing after addition of water at room temperature for less than or equal to 5 minutes.

7. The method of claim 1, wherein mixing the cathode active material particles with the lithium niobate precursor solution attaches lithium niobate precursors to a surface of the cathode active material particles.

8. A method for coating cathode active material particles, comprising:
mixing cathode active material particles with a lithium niobate precursor solution;
adding water to the mixture of lithium niobate precursor solution and cathode active material particles at a rate favoring hydrolysis of a lithium niobate precursor over condensation of the lithium niobate precursor; and
heating the hydrolyzed mixture to obtain an amorphous lithium niobate coating on the cathode active material particles.

9. The method of claim 8, wherein the rate favoring hydrolysis of the lithium niobate precursor solution of over condensation of the lithium niobate precursor is less than or equal to 5 mL/min addition of a 5 vol % solution of water in a non-aqueous solvent.

10. The method of claim 8, wherein adding water includes adding water as a water solution in ethanol.

11. The method of claim 8, wherein a thickness of the amorphous lithium niobate coating is between 5 nm and 60 nm.

12. The method of claim 8, wherein the amorphous lithium niobate coating conforms to protrusions and indents on a surface of the cathode active material particles.

13. The method of claim 8, wherein the amorphous lithium niobate coating is molecularly homogeneous.

14. A solid state lithium ion battery, comprising:
an anode current collector, an anode material coating, a separator coating, and a cathode material coating, wherein the cathode material coating includes LiNbO₃ coated cathode active material particles formed by:
preparing a lithium niobate precursor solution wherein a molar ratio of lithium to niobium in the lithium niobate precursor solution is determined by a surface composition of cathode active material particles;
mixing the cathode active material particles with the lithium niobate precursor solution;
hydrolyzing the mixture of lithium niobate precursor solution and cathode active material particles; and
heating the hydrolyzed mixture to obtain the cathode active material particles coated with amorphous lithium niobate.

15. The solid state lithium ion battery of claim 14, wherein the separator coating is formed of sulfide based solid state electrolyte.

16. The solid state lithium ion battery of claim 14, wherein the cathode active material particles are NCM811 particles.

17. The solid state lithium ion battery of claim 16, wherein the NCM811 particles are single crystalline particles.

18. The solid state lithium ion battery of claim 14, wherein a D50 of the cathode active material particles is in a range of 3 μm to 5 μm.

19. The solid state lithium ion battery of claim 14, wherein a LiNbO₃ coating of the LiNbO₃ coated cathode active material particles is homogeneous and amorphous.

20. The solid state lithium ion battery of claim 14, wherein a charge transfer resistance of the solid state lithium ion battery is decreased compared a charge transfer resistance of a solid state lithium ion battery including uncoated cathode active material particles.
